(19) United States
(12) Patent Application Publication
(10) Pub. No.: US 2025/0007105 A1
(43) Pub. Date: Jan. 2, 2025

(54) POWER STORAGE MODULE

(71) Applicant: TOYOTA JIDOSHA KABUSHIKI KAISHA, Toyota-shi (JP)

(72) Inventors: Yosuke SHIMURA, Toyota-shi (JP); Yoshiro OBAYASHI, Toyota-shi (JP); Atsushi YAMANAKA, Nagoya-shi (JP); Masashi CHIHARA, Nagoya-shi (JP); Kazuki SUGIE, Miyoshi-shi (JP); Kosuke YONEKAWA, Nisshin-shi (JP); Yasuhiro HIRAO, Toyota-shi (JP)

(73) Assignee: TOYOTA JIDOSHA KABUSHIKI KAISHA, Toyota-shi (JP)

(21) Appl. No.: 18/678,827

(22) Filed: May 30, 2024

(30) Foreign Application Priority Data
Jun. 28, 2023 (JP) 2023-106078

(51) Int. Cl. H01M 50/507; H01M 50/209; H01M 50/51; H01M 50/548; H01M 50/557

(52) U.S. Cl. CPC H01M 50/507; H01M 50/209; H01M 50/548; H01M 50/557; H01M 50/51

(57) ABSTRACT

A power storage module includes a plurality of power storage cells, a module case, and a connection member. The plurality of power storage cells each include an electrode assembly, a cell case, and an external terminal. The external terminal is electrically connected to the electrode assembly, located outside the cell case, and disposed at a side of the cell case in a second direction orthogonal to a first direction. The module case includes a bottom surface portion and a peripheral side surface portion. The connection member is in contact with the external terminal of each of power storage cells adjacent to each other, among the plurality of power storage cells. At least a part of the connection member is embedded in the peripheral side surface portion.

### CROSS REFERENCE TO RELATED APPLICATIONS

This nonprovisional application is based on Japanese Patent Application No. 2023-106078 filed on Jun. 28, 2023 with the Japan Patent Office, the entire contents of which are hereby incorporated by reference.

### BACKGROUND

### Field

The present disclosure relates to a power storage module.

### Description of the Background Art

U.S. Patent Application Publication No. 2016/0372793 discloses a conventional rechargeable battery module. The rechargeable battery module includes a plurality of rechargeable batteries and a connection member that electrically connects one of the plurality of rechargeable batteries. The rechargeable battery includes an electrode assembly, a case, a lid plate, a first sub terminal, and a second sub terminal. The lid plate seals the opening of the case. The first sub terminal includes a first portion and a second portion formed integrally with the first portion. The first portion is disposed at one end of the lid plate. The second portion is disposed on the outer surface of the case. The connection member includes a first connection member. The first connection member is bonded to the outer surface of the second portion of the first sub terminal of the adjacent rechargeable battery among the plurality of rechargeable batteries.

### SUMMARY

In the power storage module disclosed in U.S. Patent Application Publication No. 2016/0372793, the connection member is positioned laterally of the power storage cell. Therefore, it is difficult to connect the connection member and the external terminal as compared with the case where the connection member is positioned above the power storage cell. Therefore, it is difficult to assemble the power storage module.

The present disclosure is made in view of the above problem, and it is an object of the present disclosure to provide a power storage module that is easy to assemble.

A power storage module according to the present disclosure includes a plurality of power storage cells, a module case, and a connection member. The power storage cells are arranged in a first direction. The module case contains the plurality of power storage cells. The connection member electrically connects the plurality of power storage cells to each other. The plurality of power storage cells each include an electrode assembly, a cell case, and an external terminal. The cell case contains the electrode assembly. The external terminal is electrically connected to the electrode assembly, located outside the cell case, and disposed at a side of the cell case in a second direction orthogonal to the first direction. The module case includes a bottom surface portion and a peripheral side surface portion. The bottom surface portion is located at a side of the plurality of power storage cells in a third direction orthogonal to both the first direction and the second direction. The peripheral side surface portion extends upright in the third direction, from the bottom surface portion, and surrounds the plurality of power storage cells. The connection member is in contact with the external terminal of each of power storage cells adjacent to each other, among the plurality of storage cells. At least a part of the connection member is embedded in the peripheral side surface portion.

In the above configuration, since at least a part of the connection member is embedded in the peripheral side surface portion, alignment of the connection member with respect to the external terminal of the power storage cell is facilitated. Consequently, it is possible to provide a power storage module which is easy to assemble.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage module according to an embodiment of the present disclosure.

FIG. 2 is a plan view schematically showing the power storage module according to an embodiment of the present disclosure.

FIG. 3 is a perspective view schematically showing the power storage cell according to an embodiment of the present disclosure.

FIG. 4 is a cross-sectional view of the power storage module of FIG. 2 taken along a line IV-IV of FIG. 2.

FIG. 5 is a cross-sectional view of an electrode assembly of FIG. 4 taken along the line V-V of FIG. 4.

FIG. 6 is a perspective view schematically showing a step of housing a plurality of power storage cells in a module case.

### DESCRIPTION OF THE PREFERRED EMBODIMENTS

Embodiments of the present disclosure will be described with reference to the drawings. In the drawings referred to below, the same or corresponding members are denoted by the same reference numerals.

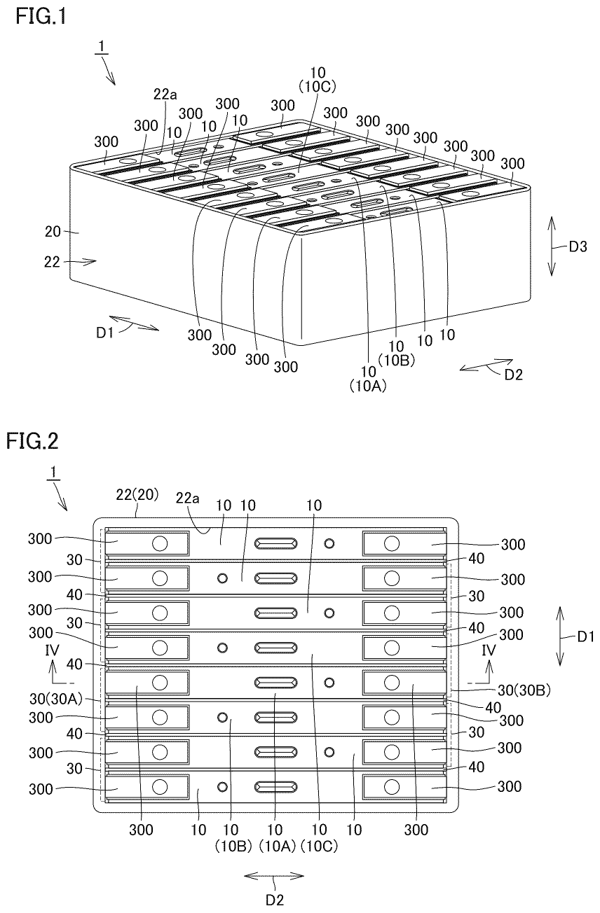

FIG. 1 is a perspective view schematically showing a power storage module according to an embodiment of the present disclosure. FIG. 2 is a plan view schematically showing a power storage module according to an embodiment of the present disclosure. As shown in FIGS. 1 and 2, a power storage module 1 according to an embodiment of the present disclosure includes a plurality of power storage cells 10, a module case 20, one or more connection members 30, and one or more spacers 40.

The plurality of power storage cells 10 are arranged in the first direction D1. Specifically, two or more power storage cells 10 are arranged side by side in the first direction D1 of the power storage cell 10. A spacer 40 is disposed between a pair of power storage cells 10 adjacent to each other.

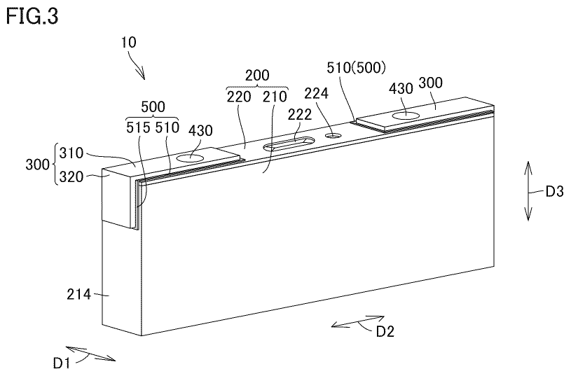

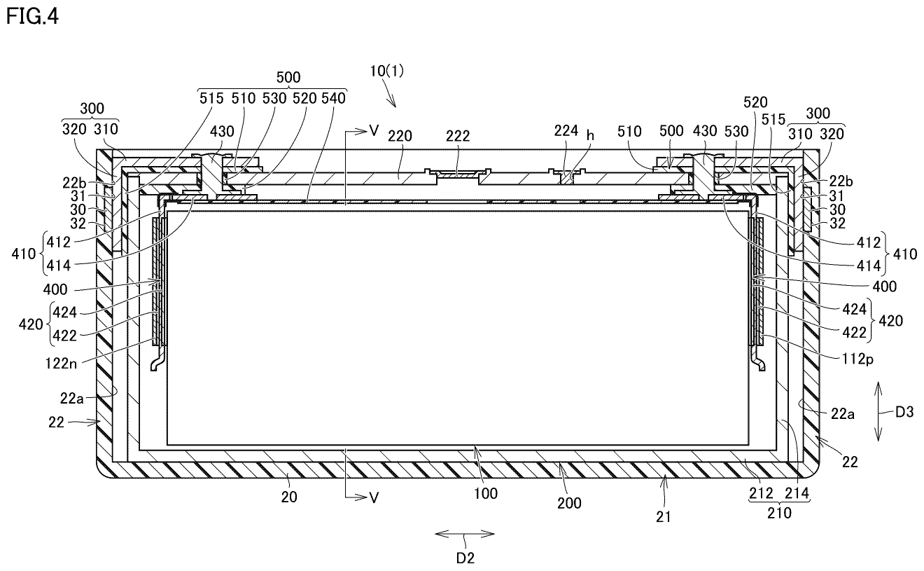

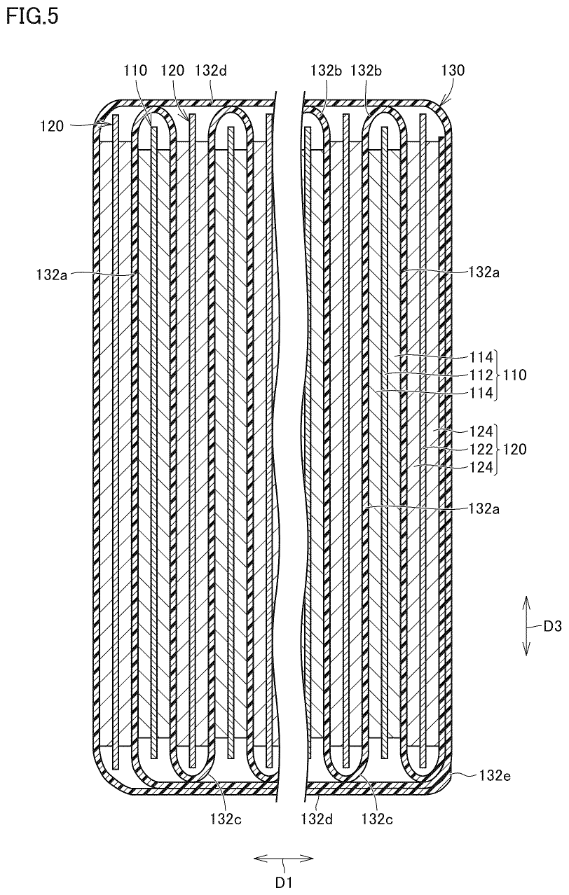

First, the configuration of each of the power storage cells 10 will be described in detail. FIG. 3 is a perspective view schematically showing a power storage cell according to an embodiment of the present disclosure. FIG. 4 is a cross-sectional view of the power storage module of FIG. 2 taken along a line IV-IV of FIG. 2.

As shown in FIGS. 3 and 4, the power storage cell 10 includes an electrode assembly 100, a cell case 200, a pair of external terminals 300, a pair of coupling members 400, and an insulating member 500.

FIG. 5 is a cross-sectional view of the electrode assembly of FIG. 4 taken along the line V-V of FIG. 4. As shown in FIG. 5, the electrode assembly 100 includes a plurality of electrodes 110 and 120 and a separator 130.

As shown in FIG. 5, the plurality of electrodes 110 and 120 are arranged side by side in the first direction D1. The plurality of electrodes 110 and 120 have a plurality of positive electrodes 110 and a plurality of negative electrodes 120.

Each positive electrode 110 is formed in a rectangular shape elongated in the second direction D2 (a direction orthogonal to the plane of FIG. 5). The second direction D2 is a direction orthogonal to the first direction D1. Each positive electrode 110 includes a positive electrode current collector foil 112 and a positive electrode active material layer 114 provided on both surfaces of the positive electrode current collector foil 112. The positive electrode current collector foil 112 has a positive electrode tab 112p (see FIG. 4) in which the positive electrode active material layer 114 is not provided. The positive electrode tab 112p protrudes toward one side in the second direction D2.

Each negative electrode 120 is formed in a rectangular shape elongated in the second direction D2. Each negative electrode 120 includes a negative electrode current collector foil 122 and a negative electrode active material layer 124 provided on both surfaces of the negative electrode current collector foil 122. As shown in FIG. 4, the negative electrode current collector foil 122 has a negative electrode tab 122n (see FIG. 4) in which the negative electrode active material layer 124 is not provided. The negative electrode tab 122n protrudes toward the other side in the second direction D2.

The separator 130 insulates the positive electrode 110 from the negative electrode 120. The separator 130 is made of an insulating material, and has minute voids that allow penetration of ions. As shown in FIG. 5, the separator 130 is folded.

The separator 130 has a rectangular shape before being folded. The separator 130 is folded between the electrodes 110 and 120. The separator 130 includes a plurality of intervening portions 132a, a plurality of upper folded portions 132b, a plurality of lower folded portions 132c, and an outermost covering portion 132d.

Each intervening portion 132a is interposed between a pair of electrodes 110 and 120 adjacent to each other in the first direction D1. That is, each intervening portion 132a has a function of insulating the positive electrode 110 and the negative electrode 120. Each intervening portion 132a is configured by a rectangular region.

The upper folded portions 132b connects an upper end portion of one of the plurality of intervening portions 132a and an upper end portion of the intervening portion 132a adjacent to the one intervening portion 132a on one side of the plurality of intervening portions 132a in the first direction D1. In the present embodiment, the upper folded portion 132b is disposed above the positive electrode 110.

Each lower folded portion 132c connects a lower end portion of the one intervening portion of the plurality of intervening portions 132a and a lower end portion of the intervening portion 132a adjacent to the one intervening portion on the other side of the plurality of intervening portions 132a in the first direction D1. In the present embodiment, the lower folded portion 132c is disposed below the negative electrode 120. In other words, the negative electrode 120 is disposed on the lower folded portion 132c.

The outermost covering portions 132d collectively cover the upper folded portions 132b and the lower folded portions 132c. More specifically, the outermost covering portion 132d covers all of the electrodes 110 and 120, all of the intervening portions 132a, all of the upper folded portions 132b, and all of the lower folded portions 132c while winding around the central axis parallel to the second direction D2. The terminal end 132e of the outermost covering portion 132d is set in a range not overlapping the positive electrode active material layer 114 and the negative electrode active material layer 124 in the first direction D1. In the present embodiment, the terminal end 132e of the outermost covering portion 132d is provided below each of the electrodes 110 and 120. The peripheral surfaces and bottom surfaces of the plurality of electrodes 110 and 120 and the separator 130 are covered with an insulating film (not shown).

As shown in FIGS. 3 and 4, the cell case 200 houses the electrode assembly 100. The cell case 200 contains an electrolyte solution (not shown). The cell case 200 is sealed. The cell case 200 includes a case body 210 and a lid 220.

The case body 210 has an opening that opens upward. The case body 210 is made of metal such as aluminum. The case body 210 includes a bottom wall 212 and a peripheral wall 214. The bottom wall 212 is formed in a rectangular and flat plate shape. The peripheral wall 214 extends upright from the bottom wall 212. The peripheral wall 214 is formed in a quadrangular cylindrical shape. The length of the peripheral wall 214 in the second direction D2 is longer than the length of the peripheral wall 214 in the first direction D1. The length of the peripheral wall 214 in the third direction D3 is longer than the length of the peripheral wall 214 in the first direction D1. The third direction D3 is a direction orthogonal to both the first direction D1 and the second direction D2.

The lid 220 closes the opening of the case body 210. The lid 220 is connected to the opening by welding or the like. The lid 220 is formed in a flat plate shape. The lid 220 is made of metal such as aluminum. The lid 220 includes a pressure release valve 222 and a sealing member 224.

The pressure release valve 222 is formed at the center of the lid 220. The pressure release valve 222 is formed so as to break when the internal pressure of the cell case 200 becomes equal to or higher than a predetermined pressure. When the pressure release valve 222 breaks, the gas in the cell case 200 is released to the outside of the cell case 200 through the pressure release valve 222, so that the internal pressure of the cell case 200 decreases.

The sealing member 224 seals the liquid injection port h formed in the lid 220. The liquid injection port h is a through hole for injecting the electrolyte solution into the cell case 200 in the manufacturing process of the power storage cell 10. After the electrolyte solution is injected into the case body 210 through the liquid injection port h, the liquid injection port h is sealed by the sealing member 224.

Each of the pair of external terminals 300 is electrically connected to the electrode assembly 100 (details will be described later). Each of the pair of external terminals 300 is disposed outside the cell case 200. Each of the pair of external terminals 300 is disposed at a side of the cell case 200 on both sides in the second direction D2 orthogonal to the first direction D1 (see FIG. 4 and the like). Thus, by bonding the external terminal 300 and the connection member 30 described later in the second direction D2, the power storage module 1 can be reduced in height in the third direction D3.

The pair of external terminals 300 is fixed to the cell case 200. One of the pair of external terminals 300 is a positive electrode external terminal and the other is a negative electrode external terminal. Each external terminal 300 is fixed to the upper surface of the lid 220 via an upper insulating portion 510 described later. Each external terminal 300 is made of a metal such as aluminum.

Each of the pair of external terminals 300 includes a first terminal portion 310 and a second terminal portion 320. The first terminal portion 310 is positioned above the cell case 200. The first terminal portion 310 is fixed to the upper surface of the lid 220 via the upper insulating portion 510. The first terminal portion 310 is formed, for example, in a rectangular parallelepiped shape.

The second terminal portion 320 extends from the first terminal portion 310 along the side surface of the cell case 200. More specifically, the second terminal portion 320 extends along both side portions of the peripheral wall 214 of the case body 210 in the second direction D2.

The pair of coupling members 400 connects the plurality of electrode tabs 112p and 122n to the external terminal 300. One of the coupling members 400 connects the plurality of positive electrode tabs 112p and the positive electrode external terminal 300, and the other coupling member 400 connects the plurality of negative electrode tabs 122n and the negative electrode external terminal 300. Since each of the pair of coupling members 400 has substantially the same structure, one of the coupling members 400 will be described below.

The coupling member 400 includes a current collecting tab 410, a sub tab 420, and a connecting pin 430.

The current collecting tab 410 has a lateral portion 412 and an upper portion 414. The lateral portion 412 is positioned on the lateral side of the electrode assembly 100 in the second direction D2. The upper portion 414 is positioned above the electrode assembly 100. The upper portion 414 extends inward in the second direction D2 from the upper end of the lateral portion 412.

The sub tab 420 connects the plurality of positive electrode tabs 112p to the current collecting tab 410. One end 422 of the sub tab 420 is connected to the plurality of positive electrode tabs 112p by welding or the like, and the other end 424 of the sub tab 420 is connected to the lateral portion 412 of the current collecting tab 410 by welding or the like.

The connecting pin 430 connects the current collecting tab 410 and the first terminal portion 310 of the external terminal 300. The connecting pin 430 connects the upper portion 414 and the first terminal portion 310 of the external terminal 300. Specifically, the lower end portion of the connecting pin 430 is connected to the upper portion 414 by welding or the like in a state of being inserted into a through hole provided in the upper portion 414, and the upper end portion of the connecting pin 430 is connected to the external terminal 300 by welding, caulking or the like in a state of being inserted into a through hole provided in the first terminal portion 310 of the external terminal 300.

The insulating member 500 insulates the cell case 200 from the coupling member 400. The insulating member 500 includes an upper insulating portion 510, a lateral insulating portion 515, a lower insulating portion 520, an insulating tube 530, and an insulating plate 540.

The upper insulating portion 510 is fixed to the upper surface of the lid 220. The upper insulating portion 510 is disposed between the lid 220 and the first terminal portion 310 of the external terminal 300. The upper insulating portion 510 is provided with an insertion hole through which the connecting pin 430 is inserted.

The lateral insulating portion 515 is disposed on the peripheral wall 214 of the case body 210. The lateral insulating portion 515 extends downward from the upper insulating portion 510. The lateral insulating portion 515 is disposed between the peripheral wall 214 of the case body 210 and the second terminal portion 320 of the external terminal 300.

The lower insulating portion 520 is fixed to the lower surface of the lid 220. The lower insulating portion 520 is disposed between the lid 220 and the lower portion of the upper portion 414 and the connecting pin 430. The lower insulating portion 520 is provided with an insertion hole through which the connecting pin 430 is inserted. The insulating tube 530 is disposed between the connecting pin 430 and the lid 220. The insulating tube 530 is formed in a cylindrical shape and surrounds the connecting pin 430.

The insulating plate 540 is fixed to the lower surface of the upper portion 414. The insulating plate 540 is disposed above the electrode assembly 100. A through hole is formed in a portion of the insulating plate 540 located below the pressure release valve 222 and a portion of the insulating plate 540 located below the liquid injection port h.

It should be noted that the insulating member 500 electrically insulating one coupling members 400 of the pair of coupling members 400 (for example, the coupling member 400 electrically connected to the positive electrode tab 112p) and the cell case 200 from each other may not have the upper insulating portion 510 and the lateral insulating portion 515. In this case, the external terminal 300 may be in direct contact with the cell case 200, or another conductive member may be disposed between the external terminal 300 and the cell case 200 instead of the upper insulating portion 510 and the lateral insulating portion 515.

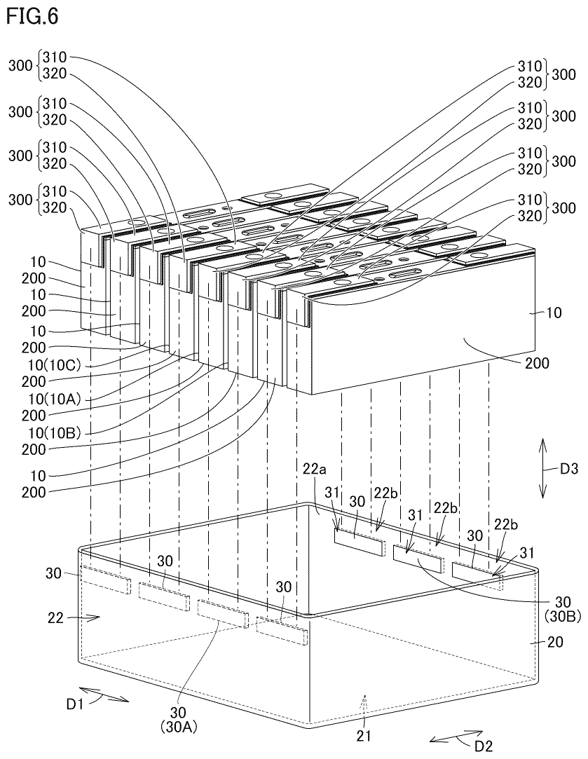

Next, the module case 20 and the connection member 30 of the power storage module 1 will be described. FIG. 6 is a perspective view schematically showing a step of housing a plurality of power storage cells in a module case.

As shown in FIGS. 1, 2, 4, and 6, the module case 20 houses a plurality of power storage cells 10. The module case 20 includes a bottom surface portion 21 and a peripheral side surface portion 22.

The bottom surface portion 21 is disposed at a side of the plurality of power storage cells 10 in the third direction D3. The bottom surface portion 21 is in contact with the plurality of power storage cells 10. The bottom surface portion 21 has a substantially rectangular outer shape when viewed from the third direction D3.

The peripheral side surface portion 22 is formed integrally with the bottom surface portion 21. The peripheral side surface portion 22 extends upright from the bottom surface portion 21 in the third direction D3, and surrounds the plurality of power storage cells 10.

The module case 20 is made of an insulating member. The module case 20 is made of a resin composition as a whole.

The connection member 30 is in contact with the external terminal 300 of each of the adjacent power storage cells 10 among the plurality of power storage cells 10. Specifically, the connection member 30 is in contact with the second terminal portion 320 of the external terminal 300 of each of the power storage cells 10 adjacent to each other among the plurality of power storage cells 10.

More specifically, the first connection member 30A is disposed on the external terminal 300 (the second terminal portion 320) of the first power storage cell 10A, which is one of the plurality of power storage cells 10, and on the external terminal 300 (the second terminal portion 320) of the second power storage cell 10B, which is another one of the two or more power storage cells 10 and is adjacent to the first power storage cell 10A. In the present embodiment, the external terminal 300 on the negative electrode 120 side of the first power storage cell 10A and the external terminal 300 on the positive electrode 110 side of the second power storage cell 10B are connected by the first connection member 30A.

The connection member 30 has conductivity. Therefore, the connection member 30 electrically connects the external terminal 300 of the first power storage cell 10A and the external terminal 300 of the second power storage cell 10B. Consequently, the connection member 30 electrically connects the plurality of power storage cells 10 to each other.

At least a part of the connection member 30 is embedded in the peripheral side surface portion 22. Thus, the rigidity of the module case 20 can be increased. The connection member 30 can be embedded in the peripheral side surface portion 22 by, for example, molding the module case 20 by injection molding a resin so as to cover a part of the connection member 30.

The connection member 30 has a connection surface 31 which comes into contact with the external terminal 300, and an embedded surface 32 which is positioned opposite to the connection surface 31 (see FIG. 4). The connection surface 31 and a portion 22b of the inner surface 22a of the peripheral side surface portion 22, which is in contact with the external terminal 300, are coplanar with each other in a virtual plane.

In the present embodiment, since the entire surface of the embedded surface 32 is in contact with the module case 20, the embedded surface 32 is not exposed to the outside. However, a part of the embedded surface 32 may be exposed to the outside of the module case 20 through the hole formed in the module case 20.

The connection member 30 is made of a metal such as aluminum or an aluminum alloy. The connection member 30 may or may not be joined to the external terminal 300 (the second terminal portion 320) by welding or the like.

In the present embodiment, the plurality of power storage cells 10 further include a third power storage cell 10C. The one or more connection members 30 further include a second connection member 30B different from the first connection member 30A.

The third power storage cell 10C is located on the side opposite to the second power storage cell 10B side when viewed from the first power storage cell 10A. The third power storage cell 10C is adjacent to the first power storage cell 10A. The second connection member 30B is disposed on the other external terminal 300 (the second terminal portion 320) of the first power storage cell 10A and on the external terminal 300 (the second terminal portion 320) of the third power storage cell 10C.

In the present embodiment, both the first connection member 30A and the second connection member 30B are provided on the inner surface 22a side of the peripheral side surface portion 22. In the present embodiment, all the connection members 30 are provided on the inner surface 22a side of the peripheral side surface portion 22.

As described above, the power storage module 1 according to one embodiment of the present disclosure includes the plurality of power storage cells 10, the module case 20, and the connection member 30. The power storage cells 10 are arranged in the first direction D1. The module case 20 contains the plurality of power storage cells 10. The connection member 30 electrically connects the plurality of power storage cells 10 to each other. Each of the plurality of power storage cells 10 includes the electrode assembly 100, the cell case 200, and the external terminal 300. The cell case 200 contains the electrode assembly 100. The external terminal 300 is electrically connected to the electrode assembly 100, located outside the cell case 200, and disposed at a side of the cell case 200 in the second direction D2 orthogonal to the first direction D1. The module case 20 includes a bottom surface portion 21 and a peripheral side surface portion 22. The bottom surface portion 21 is disposed at a side of the plurality of power storage cells 10 in the third direction D3 orthogonal to both the first direction D1 and the second direction D2. The peripheral side surface portion 22 extends upright in the third direction D3, from the bottom surface portion 21, and surrounds the plurality of power storage cells 10. The connection member 30 is in contact with the external terminal 300 of each of power storage cells 10 adjacent to each other, among the plurality of power storage cells 10. At least a part of the connection member 30 is embedded in the peripheral side surface portion 22.

According to the above configuration, since at least a part of the connection member 30 is embedded in the peripheral side surface portion 22, the alignment of the connection member 30 with respect to the external terminal 300 of the power storage cell 10 becomes easy. As a result, it is possible to provide the power storage module 1 which is easy to assemble.

The external terminal 300 is further in contact with the peripheral side surface portion 22. According to this configuration, the power storage cell 10 can be more firmly fixed to the module case 20.

Further, the connection member 30 includes the connection surface 31 located in contact with the external terminal 300, and an embedded surface 32 located opposite to the connection surface 31. The connection surface 31 and a portion 22b of the inner surface 22a of the peripheral side surface portion 22, which is in contact with the external terminal 300, are coplanar with each other in a virtual plane.

According to the above configuration, the plurality of power storage cells 10 can be easily accommodated in the module case 20. For example, as shown in FIG. 6, when the power storage cell 10 is accommodated in the module case 20 from the side opposite to the bottom surface portion 21, the opportunity for the connection member 30 to make unintended contact with the power storage cell 10 in the third direction D3 can be reduced.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage module comprising:
a plurality of power storage cells arranged in a first direction;
a module case containing the plurality of power storage cells; and
a connection member electrically connecting the plurality of power storage cells to each other, wherein
the plurality of power storage cells each include:
an electrode assembly;
a cell case containing the electrode assembly; and
an external terminal electrically connected to the electrode assembly, located outside the cell case, and disposed at a side of the cell case in a second direction orthogonal to the first direction,
the module case includes:
a bottom surface portion disposed at a side of the plurality of power storage cells in a third direction orthogonal to both the first direction and the second direction; and
a peripheral side surface portion extending upright in the third direction, from the bottom surface portion, and surrounding the plurality of power storage cells,
the connection member is in contact with the external terminal of each of power storage cells adjacent to each other, among the plurality of power storage cells, and
at least a part of the connection member is embedded in the peripheral side surface portion.

2. The power storage module according to claim 1, wherein the external terminal is further in contact with the peripheral side surface portion.

3. The power storage module according to claim 2, wherein
the connection member includes: a connection surface located in contact with the external terminal; and an embedded surface located opposite to the connection surface, and
the connection surface and a portion of an inner surface of the peripheral side surface portion are coplanar with each other in a virtual plane, the portion of the inner surface of the peripheral side surface portion being in contact with the external terminal.
